(19) United States
(12) Patent Application Publication
(10) Pub. No.: US 2025/0187331 A1
(43) Pub. Date: Jun. 12, 2025

(54) PRINTING APPARATUS, METHOD, AND COMPUTER-READABLE STORAGE MEDIUM

(71) Applicant: CANON KABUSHIKI KAISHA, Tokyo (JP)

(72) Inventor: TOMOKI KOBAYASHI, Kanagawa (JP)

(21) Appl. No.: 18/977,344

(22) Filed: Dec. 11, 2024

(30) Foreign Application Priority Data
Dec. 12, 2023 (JP) 2023-209548

(51) Int. Cl. B41J 2/045

(52) U.S. Cl. CPC B41J 2/0451; B41J 2/0454; B41J 2/04551; B41J 2/04563; B41J 2/0458

(57) ABSTRACT

A printing apparatus comprises a print head including a plurality of nozzles, a first detection unit for detecting a predetermined parameter for each nozzle, a determination unit for comparing a signal based on a detection result of the first detection unit with a threshold to determine an ink ejection status of a target nozzle, and a threshold generation unit for generating the threshold, and includes, as an operation mode, a first mode where the threshold is variable and a second mode where the threshold is fixed, wherein, in the first mode, the determination unit performs the determination for each nozzle for a predetermined number of times, the threshold generation unit changes the threshold for each time, and the threshold for the second mode is determined based on a result of the determination of the predetermined number of times.

### BACKGROUND OF THE INVENTION

### Field of the Invention

The present invention relates to mainly an inkjet printing apparatus.

### Description of the Related Art

Printing apparatuses such as ink jet printers include one that performs printing by ejecting ink from a nozzle of a print head. With the print head using a heater element, since the ink is ejected from the nozzle upon receiving thermal energy, whether the ejection is appropriately performed can be determined based on the temperature of the ink in the nozzle (refer to Japanese Patent Laid-Open No. 2012-250511).

In general, a plurality of nozzles are arranged in a print head. The determination is made for each of the plurality of nozzles through comparison between a signal value based on the temperature of the ink and a threshold, so that an ejection failure nozzle can be identified. Here, since the ink ejection status may differ between the nozzles, the threshold may be set for each nozzle.

### SUMMARY OF THE INVENTION

The present invention makes it possible to relatively easily determine an ink ejection status in an inkjet printing apparatus.

One of the aspects of the present invention provides a printing apparatus comprising a print head in which a plurality of nozzles capable of ejecting ink are arranged, a first detection unit configured to detect a predetermined parameter for each of the nozzles, a determination unit configured to compare a signal based on a result of the detection by the first detection unit with a threshold to determine an ink ejection status of a target nozzle, and a threshold generation unit configured to generate the threshold, wherein the printing apparatus has operation modes including a first mode under which the threshold is variable, and a second mode under which the threshold is fixed, and under the first mode, the determination unit makes the determination for each of the nozzles for a predetermined number of times, the threshold generation unit changes the threshold each time the determination, made for the predetermined number of times, is made, and the threshold is determined for the second mode based on a result of the determination made for the predetermined number of times.

Further features of the present invention will become apparent from the following description of exemplary embodiments (with reference to the attached drawings).

### BRIEF DESCRIPTION OF THE DRAWINGS

FIG. 1 is a block diagram illustrating a configuration example of a head control unit and a print head.

FIG. 2 is a block diagram illustrating a configuration example of a printing apparatus.

FIG. 3A is a partial schematic view of the printing apparatus.

FIG. 3B is a partial schematic view of the printing apparatus.

FIG. 4 is a schematic view illustrating an example of an arrangement mode of nozzles in the print head.

FIG. 5A is a diagram illustrating how temperature of ink changes.

FIG. 5B is a diagram illustrating how temperature of ink changes.

FIG. 5C is a diagram illustrating how temperature of ink changes.

FIG. 6A is a flowchart for determining normal ejection/ejection failure.

FIG. 6B is a flowchart for determining normal ejection/ejection failure.

FIG. 6C is a flowchart for determining normal ejection/ejection failure.

FIG. 7A is a diagram illustrating an example of a result of determining the ejection status of each nozzle.

FIG. 7B is a diagram illustrating an example of a result of determining the ejection status of each nozzle.

FIG. 8 is a schematic view of a memory region of an ejection failure count storage unit.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### (Configuration Example of Printing Apparatus)

FIG. 2 is a block diagram illustrating an example of a configuration example for realizing the functions of a printing apparatus 201 according to an embodiment. The printing apparatus 201 includes, for example, a central processing unit (CPU) 211, a read only memory (ROM) 212, a random access memory (RAM) 214, a host interface (I/F) unit 213, an image processing unit 215, a head control unit 101, and a print head 102. These components are directly/indirectly connected via a system bus, and execute information processing or signal processing, which will be described in detail below, so that desired printing can be realized using the print head 102.

In the present embodiment, the print head 102 is configured to be capable of performing printing by an inkjet method. Typically, a plurality of nozzles are arranged in the print head 102, and printing is performed by driving a corresponding heater element (electrothermal conversion element) through energization, to eject ink from each nozzle. The term “printing” as used herein refers to forming an image including a character, a symbol, a figure, a pattern, a photograph, or the like on a sheet-like print medium, and a blank that may be formed therebetween is also included in the concept of an image.

The CPU 211 reads out a control program stored in the ROM 212 and executes the program, to perform driving control on each element of the printing apparatus 201. For example, information (such as, for example, information or image data indicating an image and information realizing the printing of the same) input from a host PC 202, which is an external apparatus, is stored in the RAM 214 via the host I/F unit 213. Based on the information stored in the RAM 214, the CPU 211 causes the image processing unit 215 to convert the image data into print data, and causes the head control unit 101 and the print head 102 to perform desired printing based on the print information.

### (Printing by Print Head)

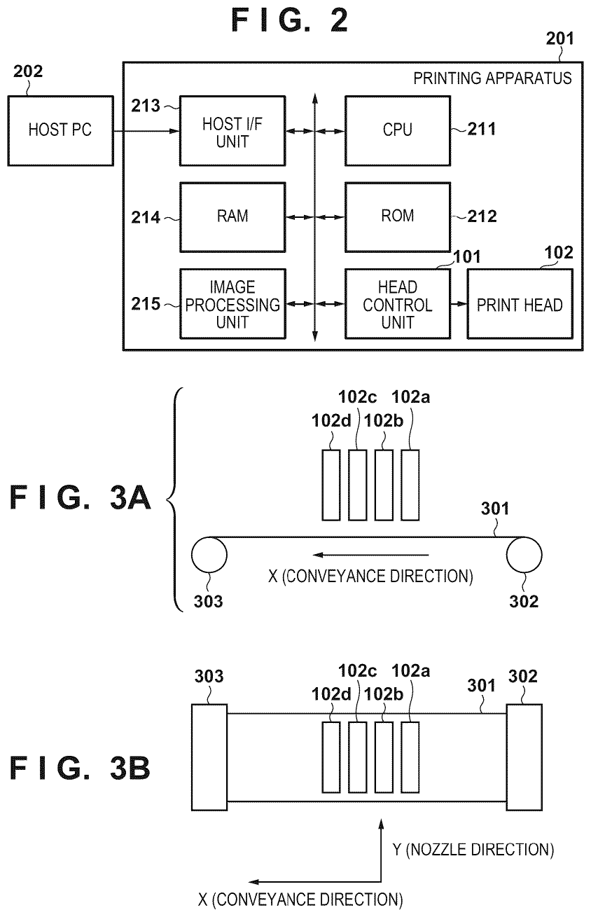

FIGS. 3A to 3B are partial schematic views of the printing apparatus 201 illustrating how printing is performed using the print head 102. FIG. 3A is a side view and FIG. 3B is a top view. The printing apparatus 201 further includes a conveyance path 301, a paper feed unit 302, and a paper discharge unit 303. The printing apparatus 201 is configured to be capable of performing color printing, and the print head 102 includes a plurality of heads 102a, 102b, 102c, and 102d capable of ejecting ink of different colors. The print medium supplied from the paper feed unit 302 is conveyed so as to pass through the conveyance path 301, during the conveyance the ink of the corresponding color is ejected (printing) onto the print medium from the head 102a or the like, and then the print medium is discharged from the paper discharge unit 303.

Note that ejection of ink from a nozzle is realized by energizing and driving a corresponding heater element. In the following description, this may be referred to as driving of a nozzle for convenience.

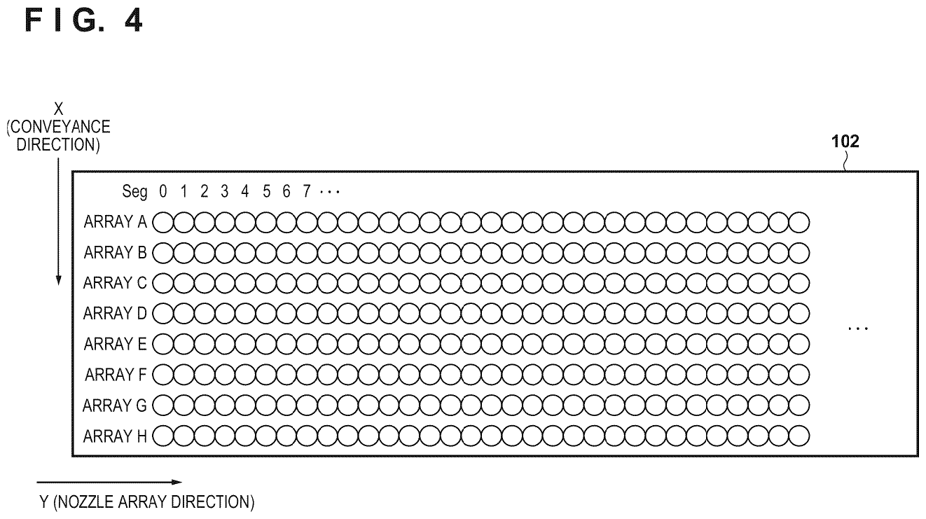

FIG. 4 is a schematic view illustrating an example of an arrangement mode of nozzles in the print head 102. In the present embodiment, the plurality of nozzles are arranged so as to form a plurality of (here, eight) nozzle arrays in the conveyance direction of the print medium. In each nozzle array, the number of nozzles corresponding to the print width are arranged in the nozzle arrangement direction. The X direction in the drawing corresponds to the conveyance direction of the print medium, and the Y direction in the drawing corresponds to the nozzle arrangement direction.

### (Printing Operation and Determination on Normal Ejection/Ejection Failure)

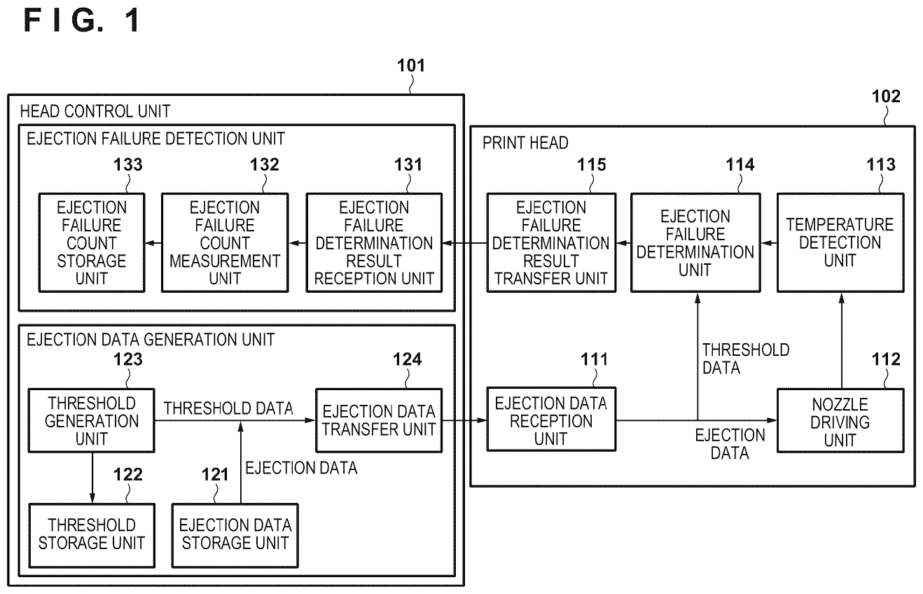

FIG. 1 is a block diagram illustrating a configuration example for realizing the functions of each of the head control unit 101 and the print head 102. The head control unit 101 includes an ejection data generation unit 103 and an ejection failure detection unit 104. The ejection data generation unit 103 includes an ejection data storage unit 121, a threshold storage unit 122, a threshold generation unit 123, and an ejection data transfer unit 124. The ejection failure detection unit 104 includes an ejection failure determination result reception unit 131, an ejection failure count measurement unit 132, and an ejection failure count storage unit 133. The print head 102 includes an ejection data reception unit 111, a nozzle driving unit 112, a temperature detection unit 113, an ejection failure determination unit 114, and an ejection failure determination result transfer unit 115.

After the print data is transferred to the head control unit 101, the ejection data generation unit 103 reads out the ejection data generated based on the print data from the ejection data storage unit 121. The ejection data is used to cause each nozzle to eject ink and includes a signal group for driving each of the plurality of nozzles.

As will be described in detail below, threshold data is generated by the threshold generation unit 123 based on the information read from the threshold storage unit 122. The threshold data is used to determine whether the ink is appropriately ejected from each nozzle, and includes a plurality of thresholds respectively corresponding to the plurality of nozzles.

The ejection data and the threshold data are transferred to the print head 102 from the ejection data transfer unit 124.

In the print head 102, the ejection data reception unit 111 receives the ejection data and the threshold data transferred, and outputs them to the nozzle driving unit 112 and the ejection failure determination unit 114, respectively. The nozzle driving unit 112 drives and makes each nozzle eject ink based on the ejection data. The temperature detection unit 113 detects the temperature of ink in the driven nozzle (or the temperature of the nozzle) as a detected temperature, and transfers a signal indicating the detection result to the ejection failure determination unit 114. The ejection failure determination unit 114 compares the signal value based on the signal (signal indicating the detected temperature) received from the temperature detection unit 113 with the corresponding threshold indicated by the threshold data, and determines whether the ink is appropriately ejected from the nozzle.

In the head control unit 101, the ejection failure determination result reception unit 131 receives the determination result from the ejection failure determination unit 114. In response to this, the ejection failure count measurement unit 132 measures the number of times the ejection has failed (the number of times it is determined that the ejection failure has occurred, that is, the number of times the ejection has failed to be appropriately implemented, and the ejection failure count may be referred to as the ejection failure determination count), and stores the result in the ejection failure count storage unit 133.

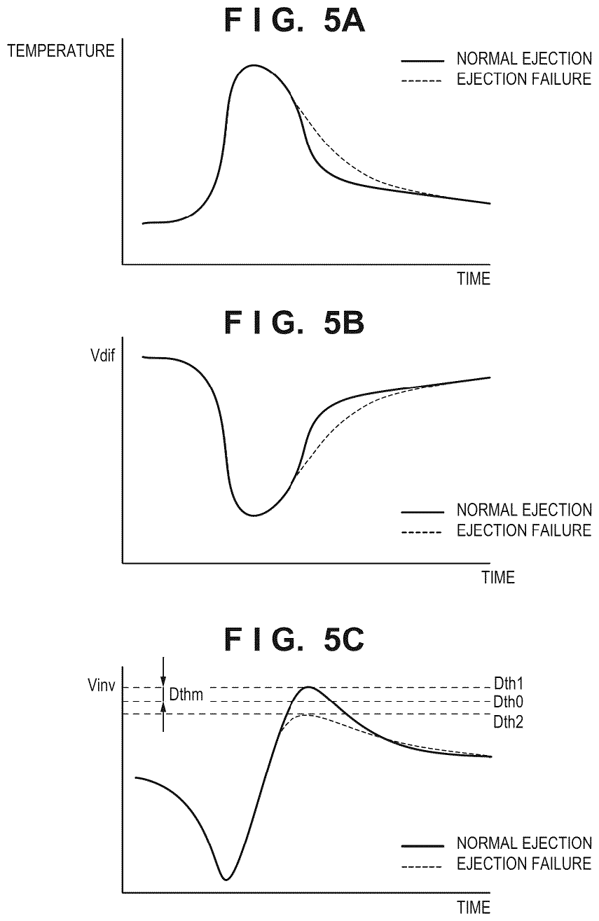

FIG. 5A illustrates how the temperature of the ink in the nozzle changes when the nozzle is driven. FIG. 5B illustrates a signal waveform of detection result Vdif of the temperature detection unit 113. In the drawing, the solid line indicates a waveform in a case where ink is appropriately ejected (in a case of normal ejection), and a broken line indicates a waveform in a case where the ink is not appropriately ejected (in a case of ejection failure). After the nozzle is driven, as can be seen FIGS. 5A and 5B, the temperature of the ink drops relatively steeply in the case of normal ejection, whereas it drops relatively gently in the case of ejection failure.

Based on such a change in the signal waveform, the ejection failure determination unit 114 calculates a temporal change amount of the detected temperature acquired by the temperature detection unit 113, and performs determination on normal ejection/ejection failure by comparing the temporal change amount with threshold data. The result of the determination by the ejection failure determination unit 114 is transferred to the head control unit 101 by the ejection failure determination result transfer unit 115.

FIG. 5C illustrates a signal waveform of a temporal change amount Vinv of the detected temperature of the temperature detection unit 113 calculated by the ejection failure determination unit 114, that is, a waveform obtained by executing differentiation processing on the signal in FIG. 5B. In order to perform the determination on normal ejection/ejection failure, a threshold needs to be set as a value between a maximum value Dth1 of the change amount Vinv in the case of normal ejection and a maximum value Dth2 of the change amount Vinv in the case of ejection failure.

How the temperature of the ink changes may differ among the nozzles (the change may vary among the nozzles). Therefore, the threshold may be set for each nozzle. As will be described in detail below, in the present embodiment, a value obtained by subtracting a predetermined value Dthm from Dth1 specified for each nozzle is used as a threshold Dth0 for performing determination on normal ejection/ejection failure. Thus, when the temporal change amount Vinv of the detected temperature reaches the threshold Dth0, the normal ejection is determined, and the ejection failure is determined otherwise. The threshold Dth0 may be referred to as threshold voltage, reference value, reference voltage, or the like.

As will be described in detail below, the threshold storage unit 122 stores a reference value for the threshold data for performing the determination for each nozzle, and the threshold generation unit 123 generates the threshold data based on the reference value and outputs the threshold data to the ejection data transfer unit 124. In the present embodiment, the threshold generation unit 123 adds an offset value Dthofs to the reference value to generate the threshold data.

FIG. 8 is a schematic view of a memory region of the ejection failure count storage unit 133. As described above, the ejection failure count storage unit 133 stores the ejection failure count measured by the ejection failure count measurement unit 132. In this example, the ejection failure count can be measured up to 15 times for each nozzle of a nozzle array with eight arrays (8192 per array). As described above, the memory size can be reduced by storing ejection failure count in the ejection failure count storage unit 133, instead of directly storing the determination result.

### (Method for Determining Normal Ejection/Ejection Failure)

For ease of description, a nozzle determined to be under the ejection failure is referred to as an ejection failure nozzle in the following description. The ejection failure nozzle can be excluded from a driving target in a subsequent printing operation.

The printing apparatus 201 according to the present embodiment has a threshold specifying mode (first mode) and an ejection failure nozzle detection mode (second mode) as operation modes. Under the threshold specifying mode, it is possible to search for and calculate or specify, for each nozzle, the threshold Dth0 for detecting an ejection failure nozzle. Under the ejection failure nozzle detection mode, an ejection failure nozzle can be detected or identified from a plurality of nozzles using the threshold Dth0 specified under the threshold specifying mode.

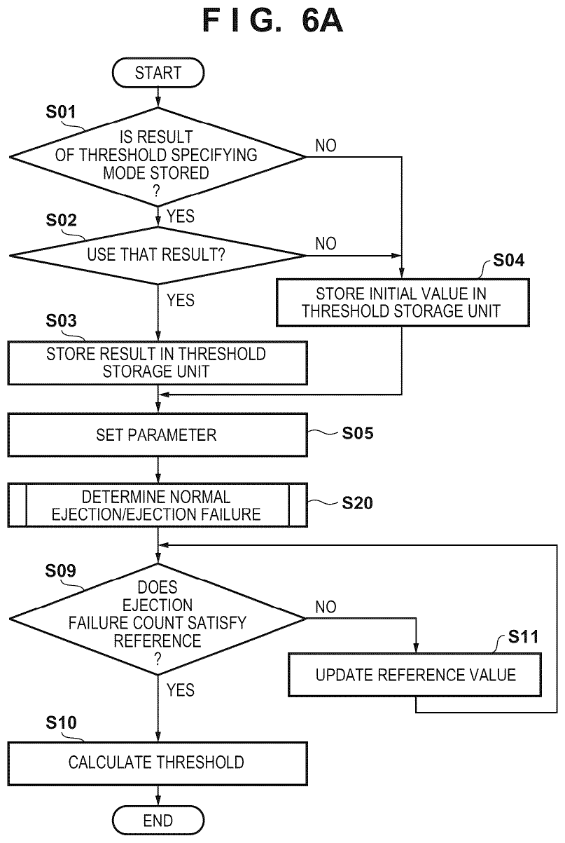

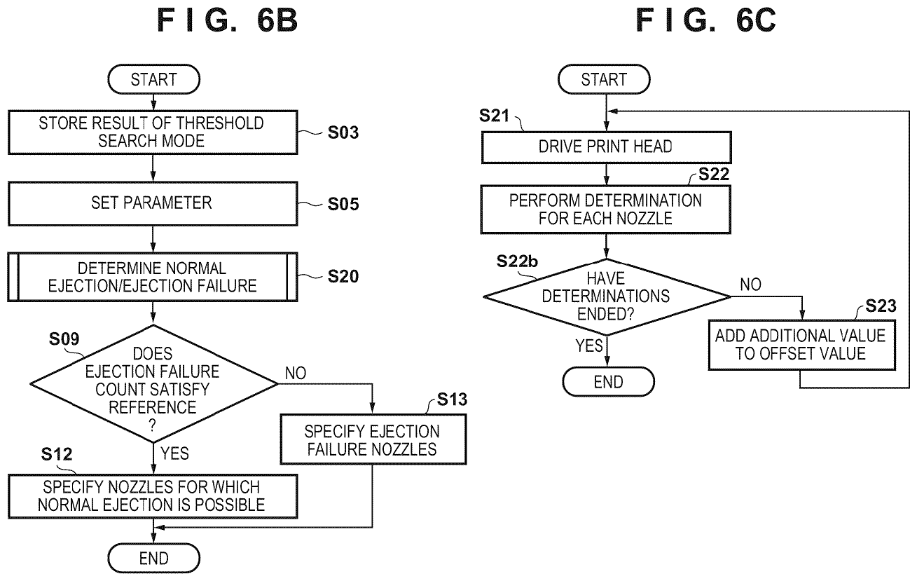

FIG. 6A is a flowchart illustrating the content of calculation by the CPU 211 under the threshold specifying mode, and FIG. 6B is a flowchart of the same under the ejection failure nozzle detection mode. FIG. 6C is a flowchart illustrating the content of calculation performed by the head control unit 101 during execution of the flowcharts for the threshold specifying mode and the ejection failure nozzle detection mode.

### Threshold Specifying Mode

Referring to FIG. 6A, under the threshold specifying mode,
in step S01 (hereinafter simply referred to as “S01”, the same applies to other steps described later), the CPU 211 determines whether the result of the previous threshold specifying mode (i.e., the threshold Dth0 specified for performing the previous ejection failure nozzle detection) is stored in the RAM 214. When the result of the previous threshold specifying mode is stored in the RAM 214, the processing proceeds to S02, otherwise, the processing proceeds to S04.

In S02, the CPU 211 determines whether to use the result of the previous threshold specifying mode stored in the RAM 214. The determination may be made based on, for example, a setting made in advance by a user. When the result of the previous threshold specifying mode is used, the processing proceeds to S03, otherwise, the processing proceeds to S04.

In S03, the CPU 211 stores the result of the previous threshold specifying mode in the threshold storage unit 122.

In S04, the CPU 211 stores the initial value of the threshold in the threshold storage unit 122. This initial value is a fixed common value set in advance for all the nozzles.

In S05, the CPU 211 sets the reference value for the threshold data in the threshold storage unit 122 and sets the offset value Dthofs to be added by the threshold generation unit 123 to 0. As will be described in detail below, under the threshold specifying mode, the offset value Dthofs is added to the reference value to search for a condition satisfying threshold.

In S20, the CPU 211 sets various parameters for the head control unit 101, drives the print head 102, and executes processing for determining an ejection status (normal ejection/ejection failure). As illustrated in FIG. 6C, S20 includes S21 to S23.

In S21, the head control unit 101 outputs ejection data to the print head 102 to drive the nozzles in a predetermined order, and acquires a result of determining the ejection status of each nozzle.

In S22, the head control unit 101 determines the ejection status for a predetermined number of times. The number of times the determination is made can be determined by, for example, a setting made by the user in advance, or may be a fixed value (for example, 15 times).

In S22b, the head control unit 101 determines whether the determination on the ejection status has ended. If the determination has ended, the flowchart ends, and if not, the processing proceeds to S23.

In S23, the head control unit 101 adds an additional value Dthadd to the offset value Dthofs. While a positive value may be typically used as the additional value Dthadd, a negative value may be used (a subtraction value may be used). In this way, the determination on the ejection status for each nozzle is performed using the threshold data updated for each determination.

In S09, the CPU 211 reads the ejection failure count for each nozzle stored in the ejection failure count storage unit 133 and determines whether the read ejection failure count is within the effective range. When the read ejection failure count is within the effective range, the processing proceeds to S10, otherwise (if the count is outside the effective range), the processing proceeds to S11. Note that the effective range may be set in advance together with an upper limit value and a lower limit value enabling normal ejection/ejection failure to be appropriately determined. Further, the effective range may also be referred to as an allowable range, a reference range, or the like.

In S11 (when the ejection failure count is outside the effective range), the CPU 211 updates the reference value for the threshold data to a smaller value when the ejection failure count exceeds the upper limit of the effective range, and updates the reference value to a larger value when the ejection failure count falls below the lower limit of the effective range. The updated reference value is stored in the threshold storage unit 122, and thereafter, the processing returns to S05 and the above determination is made again.

In S10 (when the ejection failure count is within the effective range), the CPU 211 calculates the above-described values Dth1 and Dth0 (see FIG. 5C). In the present embodiment, the value Dth1 is obtained by adding to the set reference value of the threshold data, a value as a result of multiplying the additional value Dthadd by a number corresponding to the number of times of the normal ejection is determined. Specifically, the following formula holds.

$$Dth 1 = Dx + Dthadd \times ( N - 1 ) , where \qquad ( Formula 1 )$$

$$Dx is a reference value for the set threshold data , and$$

$$N is the normal ejection count ( a value obtained by subtracting the ejection failure count from the number of times the determination is made ) .$$

The threshold Dth0 can be expressed as

$$Dth 0 = Dth 1 - Dthm , where \qquad ( Formula 2 )$$

$$Dthm is a predetermined value .$$

The threshold Dth0 thus specified is stored in the RAM 214 as a result of the threshold specifying mode.

As described above, the threshold Dth0 is set to be a value between the maximum value Dth1 of the change amount Vinv in the case of normal ejection and the maximum value Dth2 of the change amount Vinv in the case of ejection failure. Therefore, the value Dthm may be any value smaller than the difference between the values Dth1 and Dth2. For example, a value (for example, a mean value, a median value, or the like) calculated based on the values Dth1 and Dth2 may be specified in advance as a typical value of the value Dthm.

Similarly, the additional value Dthadd is required to be smaller than the difference between the values Dth1 and Dth2. In particular, since the value Dth1 is sequentially changed in S20, a value smaller than the value Dthm can be set as a typical value of the additional value Dthadd.

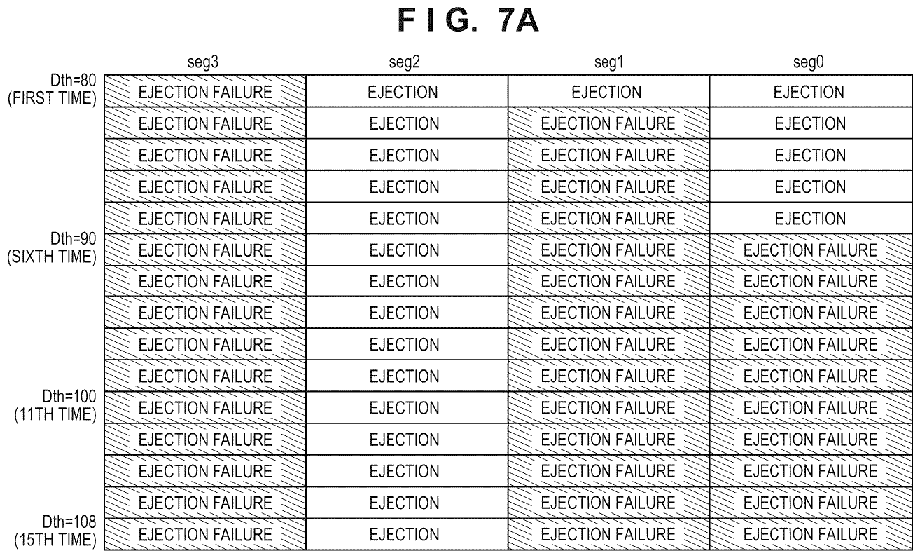

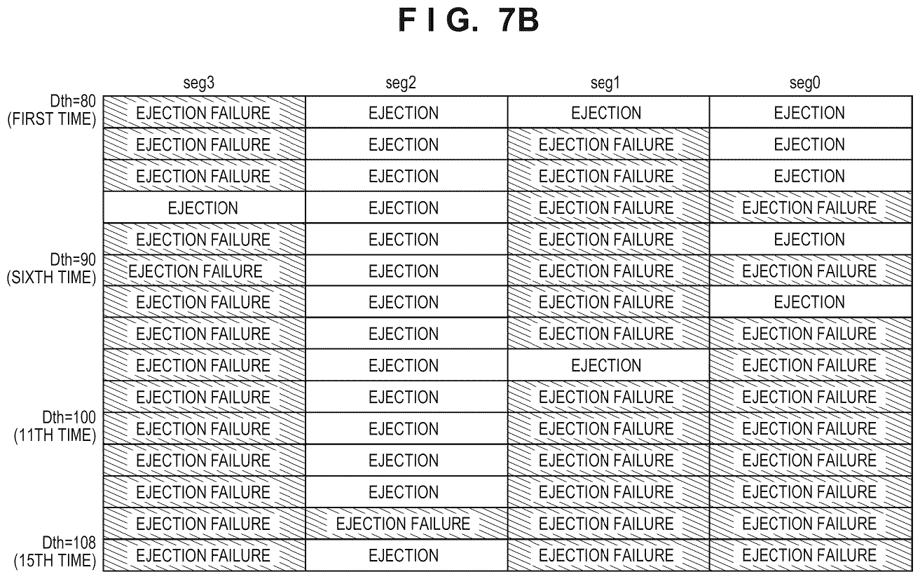

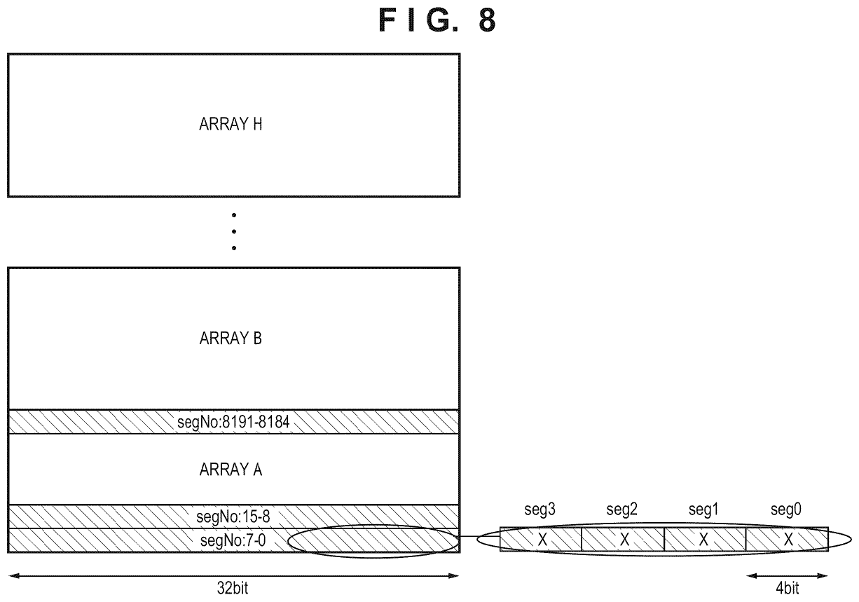

FIGS. 7A and 7B illustrate an example of the result of the determination on the ejection status for four nozzles seg0 to seg3 under the threshold specifying mode, with the determination count being 15, the reference value Dx for the threshold data being 80, and the additional value Dthadd being 2. FIG. 7A illustrates an example of the determination result in a case without an impact of noise. FIG. 7B illustrates an example of the determination result in a case under an impact of noise.

In the example of FIG. 7A, the ejection failure count for each nozzle is as follows:
10 times for the nozzle seg0;
14 times for the nozzle seg1;
0 times for the nozzle seg2; and
15 times for the nozzle seg3.

In this case, using (Formula 1) described above with the effective range of the ejection failure count being not less than once and not more than 14 times, the threshold Dth1 for each of the nozzles is calculated as follows:
88 for the nozzle seg0;
80 for the nozzle seg1;
invalid (the threshold Dth1 cannot be calculated or specified) for the nozzle seg2; and
invalid for the nozzle seg3.

In this way, the threshold Dth0 is specified for the nozzles seg0 and seg1 based on (Formula 2) described above.

In the example of FIG. 7B, the ejection failure count for each nozzle is as follows:
10 times for the nozzle seg0;
13 times for the nozzle seg1;
once for the nozzle seg2; and
14 times for the nozzle seg3.

In this case, using (Formula 1) described above with the effective range of the ejection failure count being not less than twice and not more than 13 times, the threshold Dth1 for each of the nozzles is calculated as follows:
88 for the nozzle seg0;
82 for the nozzle seg1;
invalid for the nozzle seg2; and
invalid for the nozzle seg3.

In this way, the threshold Dth0 is specified for the nozzles seg0 and seg1 based on (Formula 2) described above.

For the nozzles seg2 and seg3 determined to be invalid, the reference value Dx is updated in S11, and appropriate threshold Dth1 are searched for again in S05, S20, and S09. The effective range may be set based on the noise level.

### Ejection Failure Nozzle Detection Mode

Referring to FIG. 6B, under the ejection failure nozzle detection mode, the result of the above-described threshold specifying mode is used. Specifically, first,
in S03′, the CPU 211 stores in the threshold storage unit 122, the result of the threshold specifying mode stored in the RAM 214.

In S05′, the CPU 211 sets the offset value Dthofs to be added by the threshold generation unit 123 to 0. Under the ejection failure nozzle detection mode, the specified threshold is fixedly used (since the threshold is not searched for). Thus, the offset value Dthofs remains to be 0, meaning that the additional value Dthadd is also set to 0.

In S20′, as in FIG. 6A (as in S20 under the threshold specifying mode), the CPU 211 drives the head control unit 101 to execute processing for determining the ejection status. In this step, the determination count in S22 and S22b may be equal to or different from that under the threshold specifying mode.

S09′, the CPU 211 determines whether the ejection failure count is smaller than a predetermined value for each nozzle. When the ejection failure count is smaller than a predetermined value, the processing proceeds to S12, otherwise, the processing proceeds to S13.

In S12, the CPU 211 determines the target nozzle to be a nozzle capable of normal ejection.

In S13, the CPU 211 identifies the target nozzle to be a nozzle under ejection failure.

Although the apostrophe is added for discrimination in the above description, S03′, S05′, S20′, and S09′ under the ejection failure nozzle detection mode can be realized by the same program as that for S03, S05, S20, and S09 under the threshold specifying mode, respectively. For example, S05′ is realized by the same processing as S05 except that the setting value of the additional value Dthadd is different.

As described above, according to the present embodiment, under the threshold specifying mode, the determination on normal ejection/ejection failure is made for a plurality of times while changing the threshold Dth1 in order to specify the threshold Dth0 to be set. Accordingly, when the threshold Dth1 that satisfy the condition is calculated, the threshold Dth0 is specified based on (Formula 2) described above, and is determined as the threshold for the ejection failure nozzle detection mode. Under the threshold specifying mode, the threshold Dth1 is sequentially changed in order to specify the threshold Dth0, and the threshold Dth1 to be changed is temporarily set. Therefore, the threshold specifying mode can be regarded as an operation mode under which the threshold is variable.

On the other hand, under the ejection failure nozzle detection mode, the normal ejection/ejection failure determination is made using the threshold Dth0 specified in the threshold specifying mode. Thus, the ejection failure nozzle can be appropriately detected from the plurality of nozzles. Under the ejection failure nozzle detection mode, the threshold Dth0 specified in the threshold specifying mode is fixedly used. Thus, the ejection failure nozzle detection mode can be regarded as an operation mode in which the threshold is fixed.

By such an operation, the ink ejection status in the inkjet printing apparatus 201 can be determined relatively easily. In view of the above, the threshold Dth1 may be referred to as a variable threshold, a temporary threshold, or the like for the sake of distinction, and the threshold Dth0 may be referred to as a fixed threshold, a determined threshold, or the like for the sake of distinction.

Further, according to the present embodiment, since the ejection failure count measurement unit 132 measures the ejection failure count and the ejection failure count storage unit 133 stores the measured ejection failure count, the memory size of the ejection failure count storage unit 133 can be made small. Therefore, according to the present embodiment, the determination can be regarded as being more easily implementable.

In the present embodiment, normal ejection/ejection failure is determined based on the temperature detected by the temperature detection unit 113. Alternatively, as another example, the determination may be made based on the current amount of the heater element when driving the nozzle. In addition, in the present embodiment, the nozzle is driven by driving the heater element. Alternatively, as another embodiment, when the nozzle is driven by driving a piezoelectric element, the determination may be made based on residual vibration.

### (Program)

The present invention may be realized by preliminarily supplying a program for realizing one or more functions of the aforementioned embodiments to a system or an apparatus via a network or a storage medium, and performing a process that causes one or more processors included in a computer of the system or the apparatus to read and execute the program. Furthermore, the present invention can also be realized by a circuit (e.g., an ASIC) that realizes one or more functions.

### ADDENDUM

In the above description, the printing apparatus using the inkjet printing method is described as an example, but the printing method is not limited to the above mode. The printing apparatus may be a single function printer having only a printing function or may be a multi function printer having a plurality of functions such as a printing function, a FAX function, and a scanner function. For example, the printing apparatus may be a manufacturing apparatus for manufacturing a color filter, an electronic device, an optical device, a small structure, or the like by a predetermined printing method.

The term “printing” mentioned herein should be broadly interpreted. Therefore, the aspect of “printing” includes an object formed on a print medium which may or may not be meaningful information such as characters or figures, and the object which may or may not be visualized for a person to visually perceive.

In addition, the term “print medium” should be broadly interpreted similarly to the aforementioned “printing”. The concept of “print medium” therefore includes, in addition to generally used paper, materials that can accept ink, such as cloth, plastic film, metal plate, glass, ceramics, resin, wood, leather, and the like.

In addition, the term “ink” should be broadly interpreted similarly to the aforementioned “printing”. The concept of “ink” therefore may include, in addition to liquid that is applied onto a print medium to form images, markings, patterns, and the like, auxiliary liquid that may be applied for processing of the print medium, or treatment of ink (e.g., solidification or insolubilization of colorant in the ink applied to the print medium). In view of the above, the printing apparatus may be referred to as a liquid ejection apparatus, and to the same effect, the print head may be referred to as a liquid ejection head.

Individual components in the foregoing embodiments are named using expressions based on their main functions, the functions mentioned in the embodiments may be sub-functions and the nomenclature is not strictly limited to such expressions. In addition, the expressions are replaceable by similar expressions. To the same effect, expressions such as “unit” or “portion” can be replaced by “tool”, “component”, “member”, “structure”, “assembly” or the like. Alternatively, those expressions may be omitted or attached.

In addition, two or more elements exemplarily described as selectable in the embodiment are not strictly limited to the description and may be combined as desired. For example, each of the two or more elements exemplarily described as selectable may be additionally selected or alternatively selected. As an example, when two elements A and B are combined as desired, the expression “A and/or B” or the expression “at least one of A and B” may be used to indicate any one of A only, B only, or both A and B.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-209548, filed on Dec. 12, 2023, which is hereby incorporated by reference herein in its entirety.

What is claimed is:

1. A printing apparatus comprising:
a print head in which a plurality of nozzles capable of ejecting ink are arranged;
a first detection unit configured to detect a predetermined parameter for each of the nozzles;
a determination unit configured to compare a signal based on a result of the detection by the first detection unit with a threshold to determine an ink ejection status of a target nozzle; and
a threshold generation unit configured to generate the threshold, wherein
the printing apparatus has operation modes including:
a first mode under which the threshold is variable; and
a second mode under which the threshold is fixed, and
under the first mode, the determination unit makes the determination for each of the nozzles for a predetermined number of times, the threshold generation unit changes the threshold each time the determination, made for the predetermined number of times, is made, and the threshold is determined for the second mode based on a result of the determination made for the predetermined number of times.

2. The printing apparatus according to claim 1, further comprising an ejection failure detection unit configured to detect an ejection failure nozzle from the plurality of nozzles, wherein
under the second mode, the determination unit makes the determination on each of the nozzle for the predetermined number of times, the threshold generation unit generates the determined threshold each time the determination, made for the predetermined number of times, is made, and the ejection failure detection unit detects the ejection failure nozzle from the plurality of nozzles based on a result of the determination made for the predetermined number of times.

3. The printing apparatus according to claim 2, wherein
the determination unit determines that the target nozzle is under ejection failure based on a result of the comparison, and
the ejection failure detection unit includes a measurement unit configured to measure an ejection failure count obtained through the determination by the determination unit, and detects the ejection failure nozzle based on a result of the measurement.

4. The printing apparatus according to claim 1, wherein
the print head includes a heater element for driving each of the nozzles, and
the first detection unit is a temperature detection unit configured to detect a temperature of the ink in each of the nozzles.

5. The printing apparatus according to claim 4, wherein the signal based on a result of the detection by the temperature detection unit is obtained through differentiation processing executed on a signal corresponding to the temperature of the ink detected by the temperature detection unit.

6. The printing apparatus according to claim 1, wherein under the first mode, the threshold generation unit changes the threshold while performing addition or subtraction to or from a reference value each time the determination, made the for the predetermined number of times, is made.

7. The printing apparatus according to claim 6, wherein under the first mode, when an ejection failure count obtained through the determination made for the predetermined number of times for one of the nozzles is outside an effective range, for the one nozzle, the threshold generation unit updates the reference value to change the threshold, and the determination unit further makes the determination for the predetermined number of times.

8. The printing apparatus according to claim 7, wherein the threshold generation unit
updates the reference value to a smaller value when the ejection failure count obtained through the determination made for the predetermined number of times exceeds an upper limit of the effective range, and
updates the reference value to a larger value when the ejection failure count obtained through the determination made for the predetermined number of times falls below a lower limit of the effective range.

9. A method of controlling a printing apparatus including a print head in which a plurality of nozzles capable of ejecting ink are arranged, the method comprising:
detecting a predetermined parameter for each of the nozzles;
comparing a signal based on the detected parameter with a threshold to determine an ink ejection status of a target nozzle; and
generating the threshold, wherein
the printing apparatus has operation modes including:
a first mode under which the threshold is variable; and
a second mode under which the threshold is fixed, and
under the first mode, the determination for each of the nozzles is made for a predetermined number of times, the threshold is changed each time the determination, made for the predetermined number of times, is made, and the threshold is determined for the second mode based on a result of the determination made for the predetermined number of times.

10. A computer-readable storage medium storing a program, the program configured to cause a computer to perform each step of the method according to claim 9.
